(19) United States
(12) Patent Application Publication
(10) Pub. No.: US 2008/0166990 A1
(43) Pub. Date: Jul. 10, 2008

(54) Telephone Directory Assistance System

(76) Inventor: Shrage Toiv, Brooklyn, NY (US)

Correspondence Address: MICHAEL I KROLL, 171 STILLWELL LANE, SYOSSET, NY, 11791, US

(21) Appl. No.: 11/621,527

(22) Filed: Jan. 9, 2007

(51) Int. Cl. H04M 3/42; H04M 11/04

(52) U.S. Cl. 455/404.1; 455/414.1

(57) ABSTRACT

A communication system providing users with assistance in day to day activities using a unique communication device to automatically communicate with a predetermined remotely located entity. The remotely located entity is a service provider for a communication system for allowing a user to store contact information related to their personal life whereby the service provider can perform tasks for the user. Such tasks include contacting parties at the user's behest, medical record storage, non-emergency medical consultation services, emergency medical alert condition, periodic task reminders and periodic monitoring services.

### BACKGROUND OF THE INVENTION

1. Field of the Invention

The present invention relates to a communication system, and more specifically to a communication system providing users with assistance in day to day activities using a unique communication device to automatically communicate with a predetermined remotely located entity. The remotely located entity is a service provider for a communication system for allowing a user to store contact information related to their personal life whereby the service provider can perform tasks for the user. Such tasks include contacting parties at the user's behest, medical record storage, non-emergency medical consultation services, emergency medical alert condition, periodic task reminders and periodic monitoring services.

A method and system is provided and includes an interactive database of user contacts that is accessible by an operator for searching and selecting a call recipient and calling the recipient. Upon request the operator calls each contact number stored in the user contacts and which is associated with the desired call recipient until a connection is made between the user and the call recipient. The directory is personalized to list the best time to reach the recipient at the different locations listed.

2. Description of the Prior Art

There are other communication systems designed for subscriber assistance. Typical of these is U.S. Pat. No. 5,086,391 issued to Chambers on Feb. 4, 1992.

Another patent was issued to Darden on Apr. 20, 1993 as U.S. Pat. No. 5,204,894. Yet another U.S. Pat. No. 5,926,103 was issued to Petite on Jul. 20, 1999 and still yet another was issued on Sep. 4, 2001 to Boling, et al. as U.S. Pat. No. 6,285,867.

Another patent was published to Juang on Dec. 26, 2002 as U.S. patent application No. 2002/0196922. Yet another U.S. patent application No. 2003/0040304 was published to Cox, et al. on Feb. 27, 2003. Another was published to Timmins, et al. on Jun. 26, 2003 as U.S. application patent No. 2003/0119492 and still yet another was published on Sep. 25, 2003 to Stillman, et al. as U.S. patent application No. 2003/0179866.

Another patent was issued to Marwell, et al. on Dec. 23, 2003 as U.S. Pat. No. 6,668,055. Yet another U.S. patent application No. 2004/0029567 was published to Timmins, et al. on Feb. 12, 2004. Another patent was issued to Cox, et al. on Sep. 7, 2004 as U.S. Pat. No. 6,788,931. Yet another U.S. Pat. No. 7,010,097 was issued to Zellner, et al. on Mar. 7, 2006. Another was published to Marwell, et al. on Apr. 19, 2001 as International Patent Application Patent No. WO 01/28208 and still yet another was issued on Sep. 30, 2004 to Ljubicich as Canada Patent Application No. CA 2461520.

### U.S. Pat. No. 5,086,391

### Inventor: Bryan R. Chambers

### Issued: Feb. 4, 1992

A medical alert system for domestic use wherein the system is comprised of two major components, a device worn about the neck and a home computer. The device worn about the neck and the home computer reciprocally communicate with one another to provide the wearer of the device, as well as an attendant to the wearer of the device, both instructions for care and a method to call for emergency help. The home computer contains an audio synthesizer and a voice amplification device to communicate verbally to the individual. The device may be used to summons an ambulance from a remote location if an injured person is unable to reach a telephone. The device may also be actuated by an attitude wherein an emergency call can be made should the individual fall during a heart attack or a seizure.

### U.S. Pat. No. 5,204,894

### Inventor: Pamela Darden

### Issued: Apr. 20, 1993

A central office based service and apparatus whereby personal electronic directory (PED) subscribers may call a special number from any DTMF telephone to access their personal directory. Such users dial a special telephone number, enter their personally selected code for their directory and follow the system prompts which explain all available options and the methodology of use. The personal code is changeable by the subscriber at any time. The PED provides subscribers the ability to store names and numbers through audio signals which are preferably the subscriber's voice. The subscriber then may access his PED remotely from any DTMF telephone and have a requested name and number repeated back in the subscriber's own voice. Each entry is addressed by a portion of the name chosen by the subscriber. In case of multiple entries under the same name portion the system provides for seriatim search and announcement of the entries under that address until an affirmative response is entered by the calling subscriber. As an option the subscriber may have the number automatically dialed. The system provides subscriber access to the PED for changing, erasing or addition of entries at any time from any DTMF telephone, or of changing their personally selected code.

### U.S. Pat. No. 5,926,103

### Inventor: T. David Petite

### Issued: Jul. 20, 1999

A personalized security system in which a portable transmitter may be carried or worn by an individual and activated by the individual when in need of assistance to transmit data relating specifically to the individual. The data is received by a transceiver located in close proximity to the individual such as at an ATM, pay phone, gas pump or personal computer and is transmitted with additional data to a remote receiver. The remote receiver then forwards information relating to the data to emergency personnel who use the information to determine the location of the individual, as well as particulars relating specifically to the individual, such as name and physical description.

### U.S. Pat. No. 6,285,867

### Inventor: Brian M. Boling, et al

### Issued: Sep. 4, 2001

A combination personal audio device and emergency phone provides a user with personal audio entertainment while also providing full duplex wireless communication with an emergency response service. The apparatus includes an audio information access device, such as a compact disc player, for accessing audio information and generating an electrical audio information signal based upon the audio information. A transmitter generates an outgoing communication signal that is capable of reaching and being received by the emergency response service. A single emergency response switch is the user's sole means for activating the transmitter. When pressed, the emergency response switch activates the transmitter to generate the outgoing communication signal. A receiver receives an incoming communication signal from the emergency response service, and generates an audio communication signal based upon the incoming communication signal. An audio amplifier receives and amplifies the electrical audio information signal and the audio communication signal to produce an amplified electrical audio information and an amplified audio communication signal. A sound production device converts the amplified electrical audio information signal and the amplified audio communication signal into acoustical sound waves capable of being aurally perceived by the user. The apparatus includes an aural alarm, such as a siren, and a visual alarm, such as a flashing light, to alert individuals in an area surrounding the apparatus when an emergency situation exists.

### U.S. patent application No. 2002/0196922

### Inventor: Evan Marwell, et al

### Published: Dec. 26, 2002

A system and method for a personalized directory assistance system are provided. The system allows a user to speak with a customer service representative (CSR) by dialing an easy to remember telephone number on their phone. Specialized telephony equipment routes the call. to the customer service representative and the user's personal contact list made available to the (CSR). The CSR searches the user's personal contact list in accordance with the user's request. The CSR's terminal generates a call completion string and sends it to the telephony equipment using an out-of-band signaling network for release link transfer switching. The user's personal contact list can be populated by the user via a web browser, by interacting with the CSR, by synchronizing a personal information manager or personal digital assistant database or by sending a facsimile or the service provider.

### U.S. patent application No. 2003/0040304

### Inventor: Patrick M. Cox, et al

### Published: Feb. 27, 2003

A mobile telephone, or personal communication services subscriber who wishes directory assistance services is connected in the conventional manner to an operator who identifies a destination telephone number desired by the subscriber. As known in the prior art, the operator then initiates a call connecting the subscriber to the destination telephone number. In a preferred embodiment, the operator locates a desired destination telephone number in a computer database, and can select automatic dialing of the located number. Further, rather than dropping all further involvement with the call, the preferred embodiment of the present invention continually monitors the connection thereby established for a predetermined DTMF signal issued by the customer, such as that obtained by pressing the “*” button. If such a signal is detected, the customer is transferred to a directory assistance operator, who can then provide whatever further assistance is needed (e.g., providing further directory assistance). If a busy signal or non-answering party is detected, a customer is given a plurality of options including leaving a recorded message or page, or a predetermined alphanumeric message or page for the called party. In this case, the system automatically tries, repeatedly, to deliver the recorded message or page and, optionally, confirms successful or failed message delivery to the calling party.

### U.S. patent application No. 2003/0119492

### Inventor: Timothy A. Timmins, et al

### Published: Jun. 26, 2003

A user may utilize a communication device, e.g., a wireless phone, mobile device or personal digital assistant (PDA), to contact an information/call center where an operator provides personalized information and communications services to the user in accordance with the invention. Such services include, e.g., providing individual listing information items on a restrictive basis, caller identification service, etc. To personalize the services, at least one profile record associated with the user is used which specifies the subscribed services and the preferred ways of receiving information. For example, the profile may specify use of a special skilled operator, personal interests, methods of delivery of targeted information to the user, etc.

### U.S. patent application No. 2003/179866

### Inventor: Scott T. Stillman, et al

### Published: Sep. 25, 2003

Methods and systems are provided for storing directory assistance information in a subscriber's electronic address book for future use. If a directory number associated with the desired called party is not in the subscriber's address book, a voice services node initiates a call to a directory assistance service to obtain a directory number for the called party. If the subscriber would like to have the obtained number added to the subscriber's address book, the directory number, name and address associated with the requested directory assistance may be added to the subscriber's address book for future use by the subscriber when the subscriber needs the directory number associated with the called party.

### U.S. Pat. No. 6,668,055

### Inventor: Evan Marwell, et al

### Issued: Dec. 23, 2003

A system and method for a personalized directory assistance system are provided. The system allows a user to speak with a customer service representative (CSR) by dialing an easy to remember telephone number on their phone. Specialized telephony equipment routes the call to the customer service representative and the user's personal contact list made available to the (CSR). The CSR searches the user's personal contact list in accordance with the user's request. The CSR's terminal generates a call completion string and sends it to the telephony equipment using an out-of-band signaling network for release link transfer switching. The user's personal contact list can be populated by the user via a web browser, by interacting with the CSR, by synchronizing a personal information manager or personal digital assistant database or by sending a facsimile or the service provider.

### U.S. patent application No. 2004/0029567

### Inventor: Timothy A. Timmins, et al

### Published: Feb. 12, 2004

A user may utilize a communication device, e.g., a wireless phone, mobile device or personal digital assistant (PDA), to contact an information/call center where an operator provides personalized information and communications services to the user in accordance with the invention. Such services may include, e.g., private directory and calendar data synchronization, identity pre-validation, etc. To personalize the services, at least one profile record associated with the user which may specify, among others, the devices used by the user to communicate with the information/call center, and preferred information/call center to which an information assistance call is routed. Accordingly, services and service features provided to the user may be tailored for use with the specified devices. Security measures may also be instituted in the profile record to restrict use of certain services and service features.

### U.S. Pat. No. 6,788,931

### Inventor: Patrick M. Cox, et al

### Issued: Sep. 7, 2004

A cellular telephone subscriber who wishes directory assistance services is connected in the conventional manner to an operator who identifies a destination telephone number desired by the subscriber. As in the prior art, the operator then initiates a call connecting the subscriber to the destination telephone number. In a preferred embodiment, the operator locates a desired destination telephone number in a computer database, and can select automatic dialing of the located number. Further, rather than dropping all further involvement with the call, the preferred embodiment of the present invention continually monitors the connection thereby established for a predetermined DTMF signal issued by the customer, such as that obtained by pressing the “*” button. If such a signal is detected, the customer is transferred to a directory assistance operator, who can then provide whatever further assistance is needed (e.g. redialing a busy number, or providing further directory assistance). This feature can be disabled, manually or automatically, if the destination number makes its own use of the DTNF signals.

### U.S. Pat. No. 7,010,097

### Inventor: Samuel N. Zellner, et al

### Issued: Mar. 7, 2006

A system and method for remotely controlling one or more monitoring devices in a user's household in the event of emergency so as to more productively monitor the emergency situation on a real-time basis. The monitoring devices may include a number of multimedia instruments such as a telephone with an answering machine, a computer with a built-in digital camera, a video recording device, a cellular phone with an integrated digital camera, etc. An emergency service provider may remotely activate the monitoring devices in the user's vicinity upon receiving an emergency help request from the user, and receive the information sent by the monitoring devices to enable the service personnel to plan appropriate response to the emergency at hand. Such an arrangement allows for better monitoring of the user's vicinity in an emergency situation without the need for prolonged user participation in narrating or describing the emergency situation. Further, the emergency service provider may obtain a better picture of the emergency and its impact by controlling appropriate monitoring devices available in the user's vicinity. The remote activation and control of a monitoring device may be accomplished via the Internet.

### International Patent Application Number WO 01/28208

### Inventor: Evan Marwell et al

### Issued: Apr. 19, 2001

A system and method for a personalized directory assistance system (2) are provided. The system (2) allows a user to speak with a customer service representative (CSR) by dialing an easy to remember telephone number on their phone (4). Specialized telephony equipment routes the call to the customer service representative and the user's personal contact list made available to the CSR. The CSR searches the user's personal contact list in accordance with the user's request. The CSR's terminal (18) generates a call completion string and sends it to the telephony equipment using an out-of-band signaling network (28) for release link transfer switching. The user's personal contact list can be populated by the user via a web browser (10), by interacting with the CSR, by synchronizing a personal information manager or personal digital assistant database or by sending a facsimile or electronic mail request to the service provider.

### Canadian Patent Number CA 2 461 520

### Inventor: Philip A. Ljubicich

### Issued: Sep. 30, 2004

In accordance with the invention, an indication of connection information anonymity is stored for each individual or entity that wants to have access information made available in response to a request for directory assistance respecting such individual or entity, but does not want their actual telephone number disclosed. The information assistance service may be accessed by a caller wing a wireline telephone, wireless telephone, personal digital assistant (PDA) or other communications device seeking information assistance. An operator who attends to such an information assistance service receives a request for information assistance respecting a researched party whose connection information is designated anonymous, and transmits to the caller an access telephone number which enables the caller to call a researched party, without however providing the caller with the actual telephone number of the researched party. Such information may be transmitted to the caller via a short message service (SMS) or a wireless application protocol (WAP). It may also be transmitted by facsimile, email, paging, instant messaging, web connection or other communications.

While these telephone directory systems may be suitable for the purposes for which they were designed, they would not be as suitable for the purposes of the present invention, as hereinafter described.

### SUMMARY OF THE PRESENT INVENTION

The present invention relates to a communication system, and more specifically a communication system for allowing a user to store contact information related to their personal life whereby a remote service can perform tasks for the user. Such tasks include contacting parties at the user's behest, medical record storage, non-emergency medical consultation services, emergency medical alert condition, periodic task reminders and periodic monitoring services. Retrieval of contact information can be performed by the user or through a personal assistant remotely located. A method and system is provided and includes an interactive database of user contacts that is accessible by an operator for searching and selecting a call recipient and calling the recipient. Upon request the operator calls each contact number stored in the user contacts and which is associated with the desired call recipient until a connection is made between the user and the call recipient. The directory is personalized to list the best time to reach the recipient at the different locations listed.

A primary object of the present invention is to provide a communication system that overcomes the shortcomings of the prior art.

Another, secondary object of the present invention is to provide a communication system that facilitates searching for telephone numbers by a person other than the user.

Still another object of the present invention is to provide a communication system that enables a user to place a phone call without dialing the telephone number.

Another object of the present invention is to provide a communication device having large buttons and a speed dial button for one touch access to the TDA service.

Yet another object of the present invention is to provide a communication system that connects the user with an operator who searches a directory of user contacts and places a call between the user and a desired one of the user contacts.

Still another object of the present invention is to provide a communication system wherein the calls are placed automatically after the contact is selected by the operator.

Another object of the present invention is to provide a communication system wherein the operator may be contacted via a calling card.

Yet still another object of the present invention is to provide a communication system wherein the calling card includes a pin-based password.

A further object of the present invention is to provide a communication system whereby the operator and the user maintain contact with one another until the call to the one of the desired user contacts has been placed and connected.

Still another object of the present invention is to provide a communication system whereby the user call is directed to an operator with matching skills, such as fluency in a user language, a nurse or a doctor.

Yet another object of the present invention is to provide a communication system whereby the operator can arrange to perform a service for the user; arrange for services to be performed for the user; or purchase an item for the user.

A further object of the present invention is to provide a communication system whereby the operator can find a non-contact number for the user and add it to the contact list.

Still yet another object of the present invention is to provide a communication system that includes a user activatable transmitter pendant to be worn by the user.

Yet another object of the present invention is to provide a communication system wherein the pendant includes an activation button.

Another object of the present invention is to provide a communication system that includes a TDA call center that is reachable upon user activation of the transmitter pendant.

Still another object of the present invention is to provide an emergency communication system that includes a call box connected to a communication device.

A further object of the present invention is to provide an emergency communication system whereby depression of the activation button places a call to the TDA call center through the call box.

Yet another object of the present invention is to provide an emergency communication system whereby the dialing of the contact number is done at the TDA call center.

Another object of the present invention is to provide an emergency communication system whereby the call center recognizes the user via a caller id or other methods.

Still another object of the present invention is to provide a communication system that includes a list of contacts associated with each caller id or other methods.

Yet another object of the present invention is to provide a communication system that includes a preferred time for reaching each contact at a designated telephone number.

Another object of the present invention is to provide a communication system whereby the contact is able to receive an alphanumeric message.

A further object of the present invention is to provide a communication system whereby each contact includes a default contact method, such as a phone number, where they would like all messages to be left in the event the operator is unsuccessful at reaching the contact at the designated telephone numbers.

Still another object of the present invention is to provide a communication system whereby the user can update the contact list via the World Wide Web, facsimile, or by interacting with an operator.

Yet another object of the present invention is to provide a communication system that includes an algorithm that automatically adds the contact name and number to the user's list when the phone number is requested a predetermined number of times.

Still yet another object of the present invention is to provide a communication system whereby the user can receive a ringing telephone by pressing the activation button.

Another object of the present invention is to provide a communication system whereby the user can end the telephone conversation by pressing the activation button.

Yet another object of the present invention is to provide a communication system whereby an alarm button can be activated to alert emergency crews to the user's location.

Still another object of the present invention is to provide a communication system whereby activation of the alarm button causes at least one of an aural and visual alarm to be activated.

An even further object of the present invention is to provide a communication system that allows an elderly person to stay in communication with friends and family without requiring the elderly person to know or keep handy a directory of contact information.

Another object of the present invention is to provide a communication system that allows an elderly person to contact emergency personnel; friends; or family in case of emergency.

Still another object of the present invention is to provide a communication system that triggers a local communication device from a remote location in the event of an emergency.

Yet still another object of the present invention is to provide a communication system whereby the operator may be contacted by the user dialing a phone number.

Another object of the present invention is to provide a communication system that provides a nurse triage by phone service.

A further object of the present invention is to provide a communication system whereby the system stores user medical information that can be provided to emergency responders and/or family members.

Yet another object of the present invention is to provide a communication system whereby the medical information can include logistical information on reaching the user, or care information regarding special needs of the user.

Still another object of the present invention is to provide a communication system whereby the nurse triage service is available 24 hours per day, 7 days per week.

Yet still another object of the present invention is to provide a communication system whereby the nurses or operators have a minimum number of years of experience in a specialty, such as neonatal, psychiatric, home health, health department, pediatrics, critical care and cardiac emergency.

Another object of the present invention is to provide a communication system whereby the nurses assess users symptoms using physician-approved guidelines, but they do not diagnose.

A further object of the present invention is to provide a communication system whereby the nurse forwards the call to the appropriate level of care, such as the emergency services department or a physician's office.

Yet another object of the present invention is to provide a communication system that is simple and easy to use.

Still another object of the present invention is to provide a communication system that is inexpensive to manufacture and operate.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

### BRIEF DESCRIPTION OF THE DRAWING FIGURES

In order that the invention may be more fully understood, it will now be described, by way of example, with reference to the accompanying drawing in which:

FIG. 1 is an illustrative view of a telephone of the telephone directory assistance system of the present invention;

FIG. 2 is an illustrative view of a pendant of the telephone directory assistance system of the present invention;

FIG. 3 is an illustrative view of a call box of the telephone directory assistance system of the present invention;

FIG. 4 is an illustrative view of a contact screen of the telephone directory assistance system of the present invention;

FIG. 5 is a flow diagram of the telephone directory assistance system of the present invention;

FIG. 6 is a flow diagram of the telephone directory assistance system of the present invention;

FIG. 7 is a flow diagram of the telephone directory assistance system of the present invention;

FIG. 8 is a flow diagram of the telephone directory assistance system of the present invention; and

FIG. 9 is an illustrative view of the telephone directory assistance system of the present invention.

### DESCRIPTION OF THE REFERENCED NUMERALS

Turning now descriptively to the drawings, in which similar reference characters denote similar elements throughout the several views, the Figures illustrate the communication of the present invention. With regard to the reference numerals used, the following numbering is used throughout the various drawing Figures.
10 communication system of the present invention
12 telephone receiver
14 speaker
16 speaker phone button
18 digit buttons
20 telephone directory assistance (TDA) button
22 microphone
24 pendant
26 activation button
28 aperture
30 user attachment
32 call box
34 antenna
36 speaker/microphone
38 LED display
40 contact display screen
42 Contact name
44 contact location
46 contact telephone number
48 best times for telephone number
50 user
52 emergency personnel
54 operator voice
56 alarm
58 alarm button

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

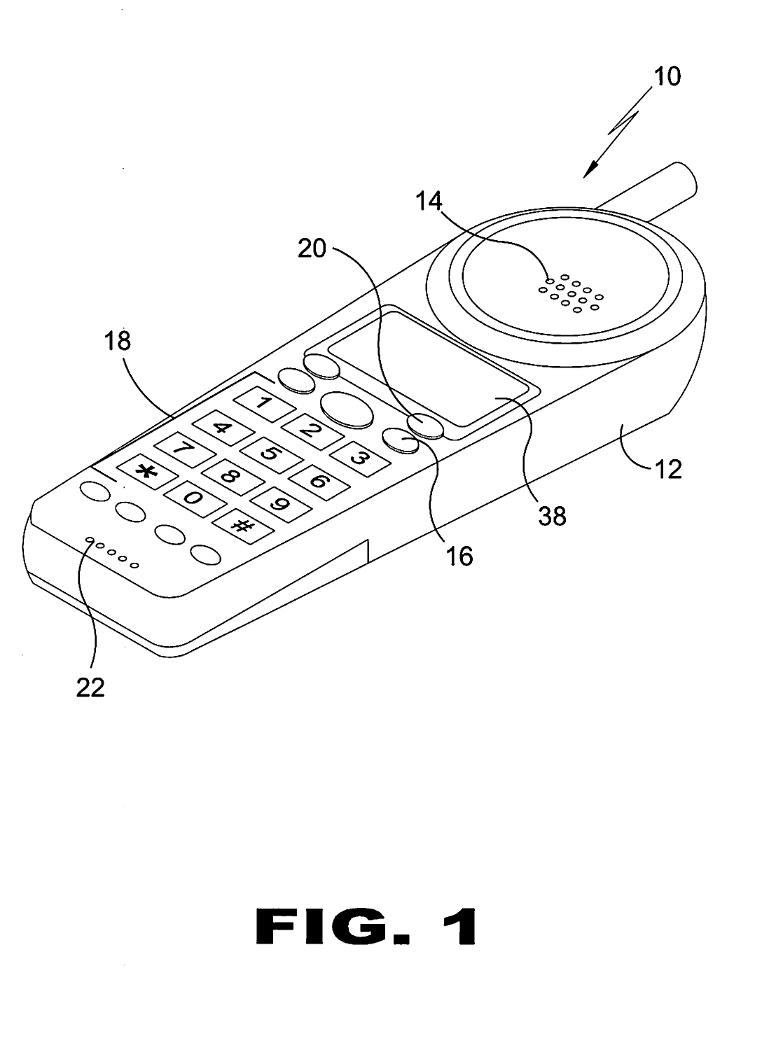

Referring to FIG. 1, shown is an illustrative view of a telephone of the telephone directory assistance system of the present invention. The telephone directory assistance system 10 provides a telecommunications device 12 having oversized buttons 18 for ease of use with a speaker phone button 16, and speed dial button 20 for connecting directly to the service provider and a LED display screen 38. Also shown are microphone 22 and speaker 14.

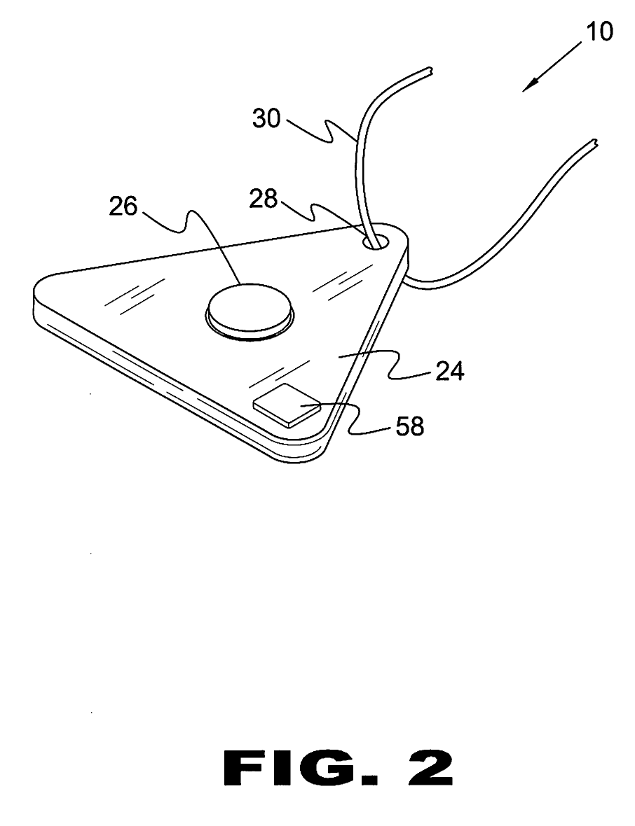

Referring to FIG. 2, shown is an illustrative view of a pendant of the telephone directory assistance system of the present invention. The telephone directory assistance system 10 further provides a communications article 24 having aperture 28 for user attachment. Pendant 24 incorporates activation button 26 whereby the user activates the two way speaker phone and connects to the call center and alarm button 58 to initiate a telephone directory assistance emergency response.

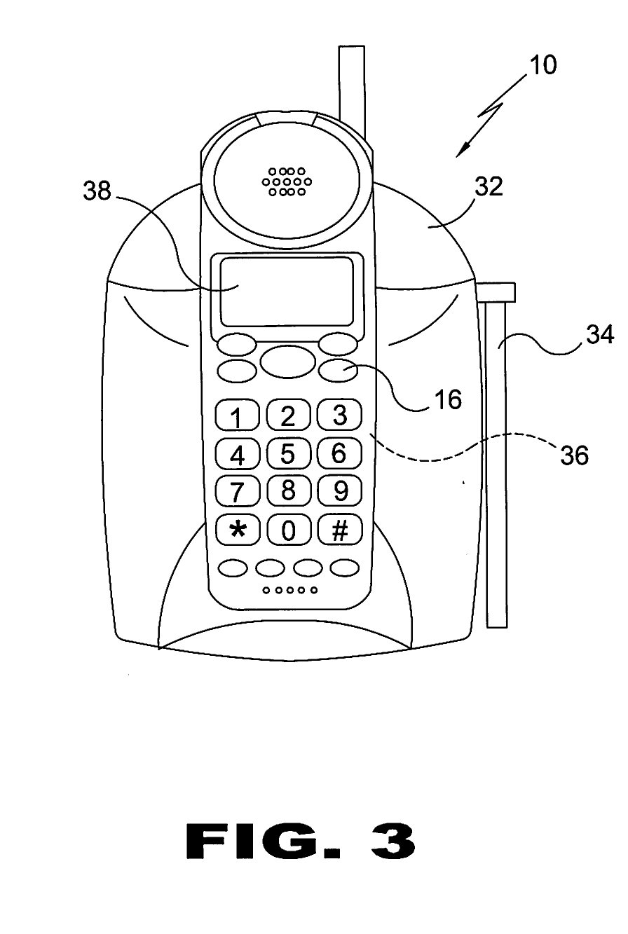

Referring to FIG. 3, shown is an illustrative view of a call box of the telephone directory assistance system of the present invention. The communications system 10 of the present invention provides call box 32 having antenna 34 and speaker/microphone 36 that serves as cradle for telephone receiver 12 with LED display 38. The call box 32 works in conjunction with pendant 24 to provide hands-free communication with the TDA call center via depressing pendant activation button 26 or by depressing telephone receiver 12 speed dial button 20 and speaker phone button 16.

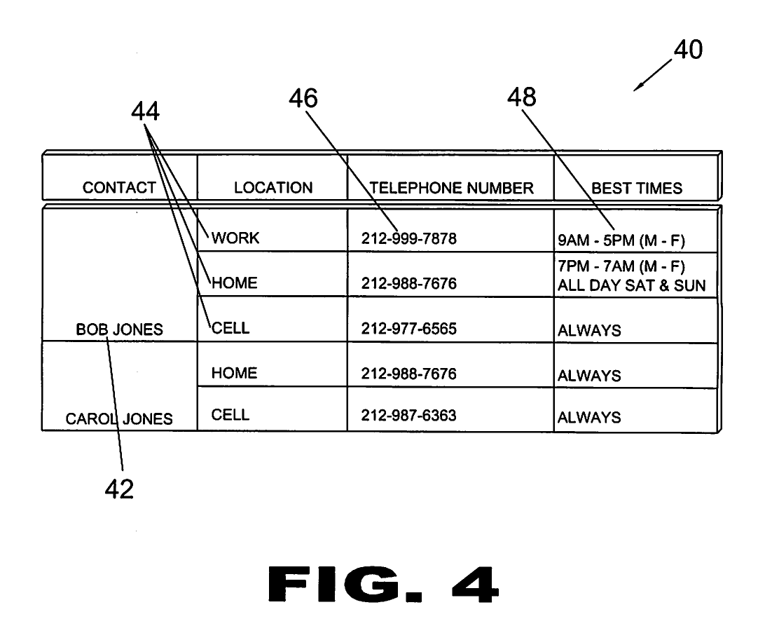

Referring to FIG. 4, shown is an illustrative view of a contact screen of the telephone directory assistance system of the present invention. Shown is an illustrative view of user contact information 40 comprising contact name 42, contact location 44, contact telephone number 46 and best times 48 for contact. Additional information can be incorporated into the user's contact information as needed.

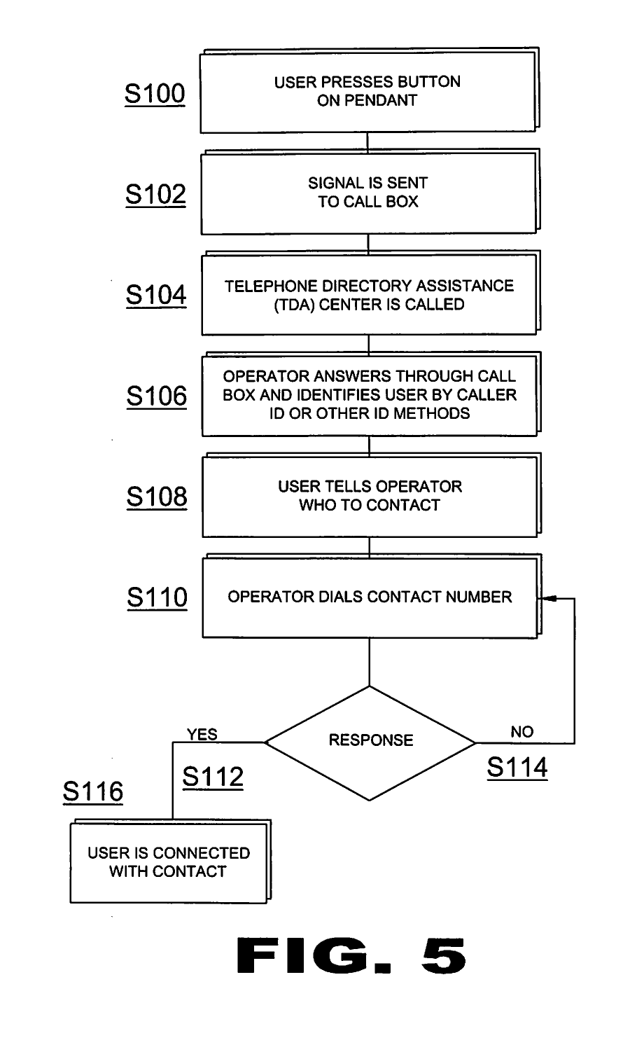

Referring to FIG. 5, shown is a flow diagram of the telephone directory assistance system of the present invention. The telephone directory assistance provides means whereby a user can initiate a call using a system provided pendant. As illustrated in Step S100, the user press activation button on pendant whereupon a signal is sent to the call box, in Step S102, which initiates call to the call center of the telephone directory assistance provider, as shown in Step S104. In Step S106, the operator answers through the call box and identifies the user by caller ID or other ID methods. The user tells the operator who to contact, in Step S108 and in Step S110, the operator dials the contact number. In Step S112, if the call is completed, the user is connected with contact as shown in Step S116. If not, the operator dials the contact number again, as shown in Step S114.

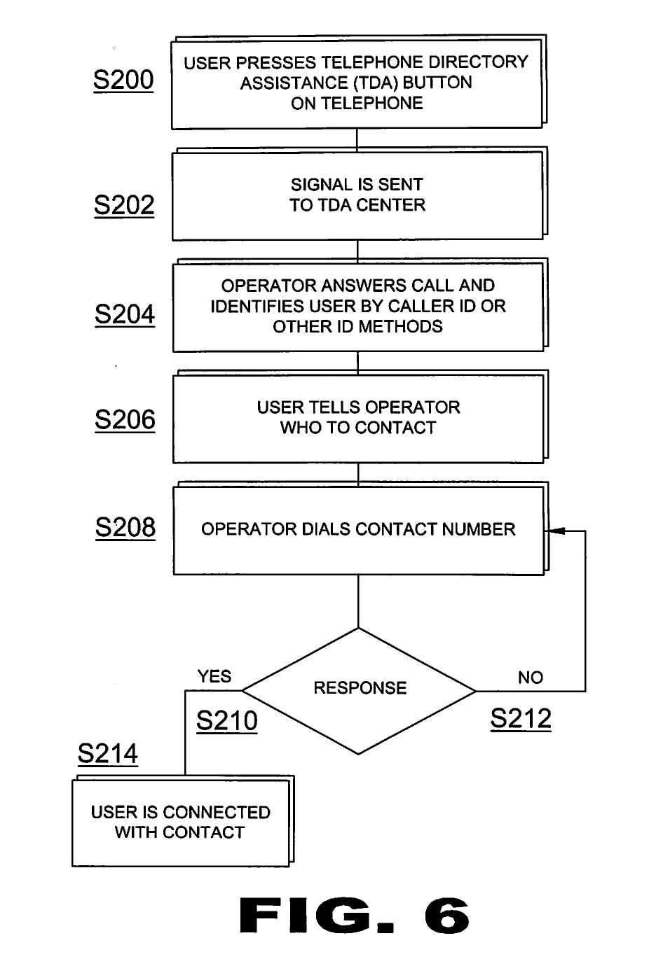

Referring to FIG. 6, shown is a flow diagram of the telephone directory assistance system of the present invention. The telephone directory assistance system also provides means whereby a user can initiate a call using the speed dial button on the telephone receiver, as illustrated in Step S200 whereupon a call is initiated to the TDA call center, as shown in Step S202. In Step S204, the operator answers the call and identifies user by caller ID or other ID method. In Step S206, the user tells the operator who to contact and the operator dials the contact number, as shown in Step S208. In Step S210, if the call is completed, the user is connected with contact as shown in Step S214. If not, the operator dials the contact number again, as shown in Step S212.

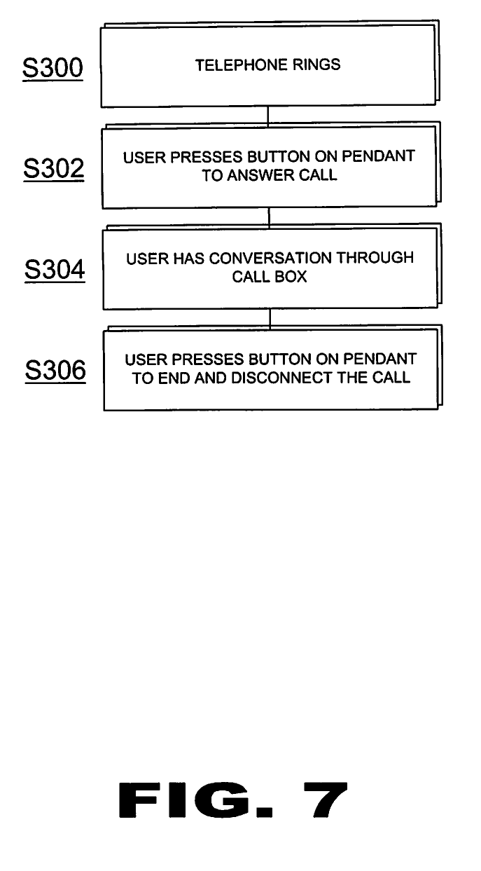

Referring to FIG. 7, shown is a flow diagram of the telephone directory assistance system of the present invention. The pendant of the present invention provides means for a user to initiate a call using the system provided pendant and answer incoming calls. As shown in Step S300, the telephone rings which the user answers by depressing the activation button on the pendant, in Step S302 which directs the call through the call box so that the user can have a hands-free conversation. When the conversation is completed, as shown in Step S306, the user depresses the activation button on the pendant to end and disconnect the call.

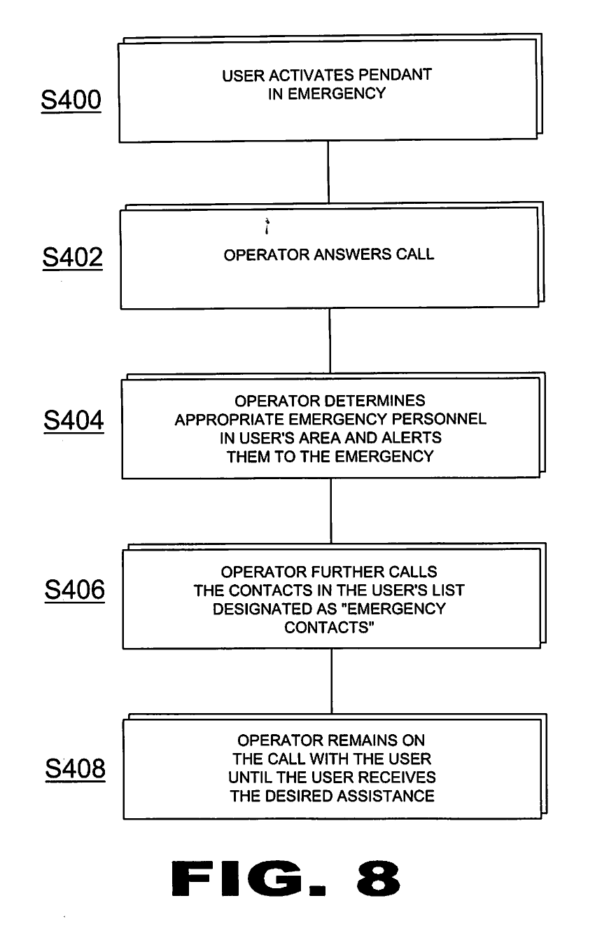

Referring to FIG. 8, shown is a flow diagram of the telephone directory assistance system of the present invention. As aforementioned, the present invention provides an article to be carried by the user whereby the user in case of emergency, shown in Step S400, activates the emergency response portion of the present invention. In Step S402, the service provider has an on-call operator for answering the user emergency call. The operator ascertains the nature of the emergency and contacts the appropriate emergency response personnel in the user's area, as shown in Step S404. In Step S406, the operator further calls the contacts in the user's list designated as “Emergency contacts” and remains on the phone with the user until the user receives the desired assistance, as shown in Step S408.

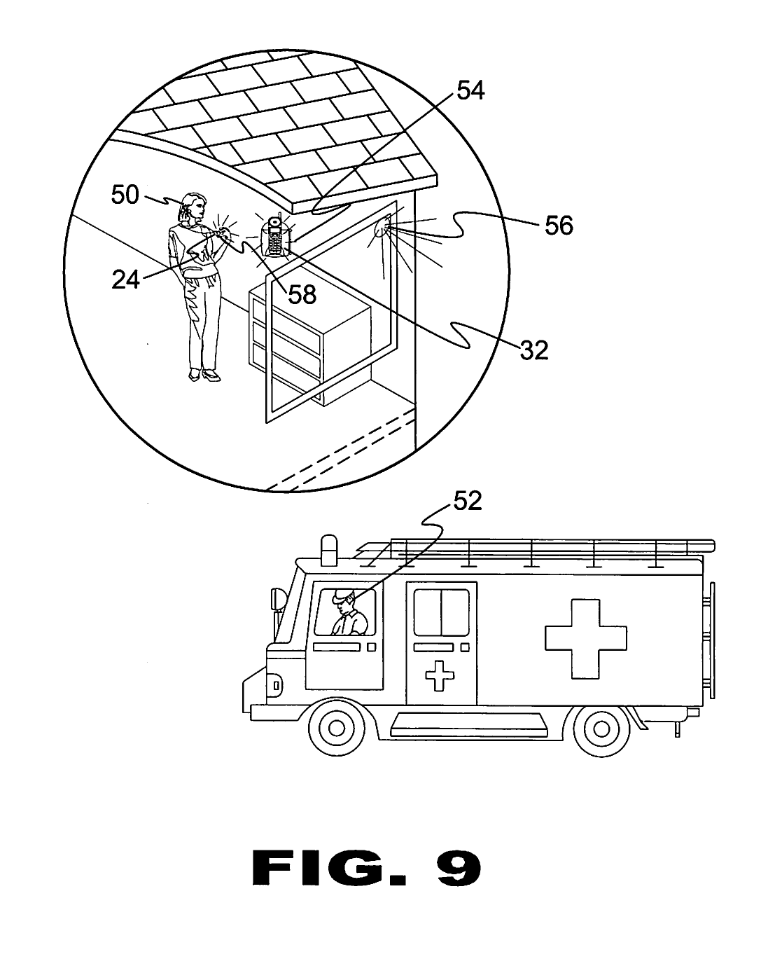

Referring to FIG. 9, shown is an illustrative view of the telephone directory assistance system of the present invention. The telephone directory assistance system 10 provides a telecommunications device 12 having oversized buttons 18 for ease of use with a speaker phone button 16, and speed dial button 20 for connecting directly to the service provider. The telephone directory assistance system 10 further provides a communications article 24 for user 50 attachment. Pendant 24 incorporates alarm button 58 whereby the user activates the two way speaker phone and connects to operator 54 at the TDA call center initiating a telephone directory assistance emergency response. The operator contact the appropriate emergency personnel 52 which may include energizing alarm 56 to aid emergency workers in locating user 50.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention

What is claimed is new and desired to be protected by Letters Patent is set forth in the appended claims:

1. A method of providing subscriber telephone directory assistance, which comprises:
a) providing a remote call center having an attendant answering subscriber calls to assist the subscriber by performing services for the subscriber;
b) furnishing the subscriber with a communications device for contacting the call center;
c) furnishing the subscriber with a wearable article that is capable of remotely initiating at least one of the communication functions of the furnished communication device; and
d) acquiring subscriber contact information for storage within an attendant retrievable database so that the attendant can provide the subscriber with the services of the telephone directory assistance system.

2. The method of claim 1, wherein the service provider stores contact information related to a subscriber's personal life so that the service provider can perform tasks for the subscriber including contacting parties at the subscriber's behest, storing subscriber's medical records, providing non-emergency medical consultation services, initiating a subscriber emergency medical alert condition, performing periodic subscriber-task reminders and periodic subscriber monitoring services.

3. A system of providing subscriber telephone directory assistance, which comprises:
a) computer hardware and software for storing, retrieving and updating a subscriber's ID and contact information;
b) a call center having a telecommunications link that is publicly accessible by subscribers;
c) a telecommunication device having a keypad of oversized buttons with one of said buttons preprogrammed with the call center number so that subscribers can access the service provider's call center by actuating a single button; and
d) a telecommunications device that can be selectively worn by the subscriber for actuating at least one of the functions of the telecommunication's device having the oversized keypad.

4. The system of claim 3 wherein the computer hardware and software for storing, retrieving and updating a subscriber's ID and contact information is accessible to the user through a communication link, such as the Internet.

5. The system of claim 4, wherein the subscribers contact information includes contact name, contact number, contact location and best times to reach the contact at the contact number.

6. The system of claim 3, wherein the call center has an attendant for completing a subscriber's call whether the called recipient is listed in the subscriber's contacts.

7. The system of claim 6, wherein the call center attendant can find a non-contact number for the subscriber, complete the call and add it to the subscriber's contact list as needed.

8. The system of claim 7, wherein the call center attendant remains on the line until the subscriber establishes contact with a desired recipient party.

9. The system of claim 8, wherein the call center provides means for a subscriber to complete a call without having to dial the number.

10. The system of claim 9, wherein the call center attendant can arrange to perform a service for the user; arrange for services to be performed for the subscriber; or purchase an item for the subscriber.

11. The system of claim 3, wherein said telecommunication device is comprised of a handheld communications device and a base serving as cradle for the handheld device.

12. The system of claim 11, wherein the handheld communication device has a speed dial button for accessing the call center; a speaker button for actuating the cradle base speaker; and an LED display for displaying text messages.

13. The system of claim 3, wherein the wearable telecommunication device is comprised of a fastener for attaching the device to the user or an article of apparel, an actuation button and an alarm button.

14. The system of claim 13, wherein said actuation button allows the user to hands-free initiate a telephone call or terminate a call.

15. The system of claim 13, wherein said alarm button triggers a subscriber medical emergency by placing a call to the call center whereupon the call center attendant can direct emergency personnel to the subscriber.

16. The system of claim 3, further providing medical triage phone services whereby subscribers can consult with licensed medical professionals on a need be basis.

17. The system of claim 16, wherein said licensed medical professionals includes nurses and doctors.
